(19) United States
(12) Patent Application Publication
(10) Pub. No.: US 2020/0094314 A1
(43) Pub. Date: Mar. 26, 2020

(54) MOLD FOR MANUFACTURING CONNECTION ROD AND METHOD TO MANUFACTURE CONNECTION ROD USING THE SAME

(71) Applicant: CHONG-LI LOU, Cixi (CN)

(72) Inventor: CHONG-LI LOU, Cixi (CN)

(21) Appl. No.: 16/141,159

(22) Filed: Sep. 25, 2018

(51) Int. Cl. B22C 9/24; F16C 7/02; B21K 1/76

(52) U.S. Cl. CPC B22C 9/24; B23P 2700/04; B21K 1/766; F16C 7/02

(57) ABSTRACT

A mold for manufacturing connection rod includes a main body. The main body is hollow to form a cavity and defines an axial direction. The cavity comprises a first section, a second section, a third section, a fourth section, and a fifth section along the axial direction. The first section has an inner diameter larger than or equal to an inner diameter of the second section. The inner diameter of the second section is larger than an inner diameter of the third section. The fifth section has an inner diameter smaller than or equal to the inner diameter of the third section. The fourth section has an inner diameter larger than the inner diameter of the third section and also larger than the inner diameter of the fifth section.

### BACKGROUND OF THE INVENTION

### Field of the Invention

The present invention relates to a mold for manufacturing connection rod and a method to manufacture connection rod.

### Description of the Prior Art

A connection rod has an expanded end and a smaller ball-joint at two opposite ends. The expanded end is formed with a hole. Generally, the expanded end is formed from a metal rod under a cold forging process, and the ball-joint is formed under a process of milling.

However, the processing speed of milling is quite low, and the products usually have sizes not completely the same. Besides, the process of milling has to be made manually to increase labor cost. On the other hand, a large amount of iron filings is generated under the process of milling Thus, extra processing of the iron filings is needed, and pollution is inevitable.

### SUMMARY OF THE INVENTION

The main object of the present invention is to provide a mold for manufacturing connection rod and a method to manufacture connection rod to reduce cost and simplify processes. In addition, the ball-joint of the connection rod is precise.

To achieve the above and other objects, a mold for manufacturing connection rod of the present invention includes a main body. The main body is hollow to form a cavity and defines an axial direction. The cavity comprises a first section, a second section, a third section, a fourth section, and a fifth section along the axial direction. The first section has an inner diameter larger than or equal to an inner diameter of the second section. The inner diameter of the second section is larger than an inner diameter of the third section. The fifth section has an inner diameter smaller than or equal to the inner diameter of the third section. The fourth section has an inner diameter larger than the inner diameter of the third section and also larger than the inner diameter of the fifth section.

To achieve the above and other objects, a method to manufacture connection rod using the mold mentioned above includes the following steps.

Prepare semi-product: Prepare a semi-product from metal. The semi-product is rod-shaped and has a first end, a second end, and an intermediate section between the first end and the second end. The first end has an outer diameter larger than or equal to an outer diameter of the intermediate section and equal to the inner diameter of the first section of the cavity. The intermediate section has an outer diameter larger than the outer diameter of the second end but equal to the inner diameter of the second section of the cavity. The second end includes a larger-diameter section closer to the intermediate section and a smaller-diameter section remote from the intermediate section. The larger-diameter section has an outer diameter than an outer diameter of the smaller-diameter section but equal to the inner diameter of the third section of the cavity. The outer diameter of the smaller-diameter section is equal to the inner diameter of the fifth section of the cavity.

Place into mold: Place the semi-product into the cavity of the main body. The first end of the semi-product is located at the first section. The intermediate section of the semi-product is located at the second section. The larger-diameter section of the semi-product is located at the third section. The smaller-diameter section of the semi-product is located at the fourth section and the fifth section. A shaping space is formed between the fourth section and the smaller-diameter section of the semi-product.

Cold forging: The semi-product is prevented from moving toward the first end by a positioning element abutting against a free end of the first end. A free end of the second end is pushed and punched by a punching rod toward the first end so that a metal material of the second end of the semi-product is squeezed into the shaping space to make the second end radially expand to form a ball-joint.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a profile of a raw material of the present invention;

FIG. 2A and FIG. 2B are illustrations showing a first shaping step of the present invention;

FIG. 3A and FIG. 3B are illustrations showing a second shaping step of the present invention;

FIG. 4A and FIG. 4B are illustrations showing a method to manufacture connection rod of the present invention;

FIG. 5 is a profile of a connection rod of the present invention;

FIG. 6 is a profile of a mold of the present invention;

FIG. 7A and FIG. 7B are illustrations showing a second embodiment of the present invention.

### DETAILED DESCRIPTION OF THE PREFERRED EMBODIMENTS

Please refer to FIG. 6, the mold 70 for manufacturing connection rod of the present invention includes a main body. The main body is hollow to form a cavity and defines an axial direction. The cavity comprises a first section 701, a second section 702, a third section 703, a fourth section 704, and a fifth section 705 along the axial direction. The first section 701 has an inner diameter larger than or equal to an inner diameter of the second section 702. The inner diameter of the second section 702 is larger than an inner diameter of the third section 703. The fifth section 705 has an inner diameter smaller than or equal to the inner diameter of the third section 703. The fourth section 704 has an inner diameter larger than the inner diameter of the third section 703 and also larger than the inner diameter of the fifth section 705.

In the present embodiment, the fourth section 704 includes a front section 7041 and a rear section 7042 along the axial direction. An inner diameter of the front section 7041 is expanded from an end thereof near the third section 703 toward the rear section 7042. An inner diameter of the rear section 7042 is tapered from an end thereof near the front section 7041 toward the fifth section 705 so that the fourth section 704 has a maximum diameter at a junction between the front section 7041 and the rear section 7042. Practically, the main body comprises a first half-mold 71 and a second half-mold 72. The first half-mold 71 has a first cavity, and the second half-mold 72 has a second cavity. The first half-mold 71 and the second half-mold 72 are connected axially so that the first cavity and the second cavity form the cavity together. In other possible embodiments, both the front section and the rear section can be located at the first half-mold or the second half-mold. Alternatively, the front section and part of the rear section are located at the first half-mold, or the rear section and part of the front section are located at the second half-mold. Besides, the first section 701 and the second section 702 are connected by an inclined face therebetween. Similarly, the second section 702 and the third section 703 are connected by an inclined face therebetween, and the third section 703 and the fourth section 704 are connected by an inclined face therebetween.

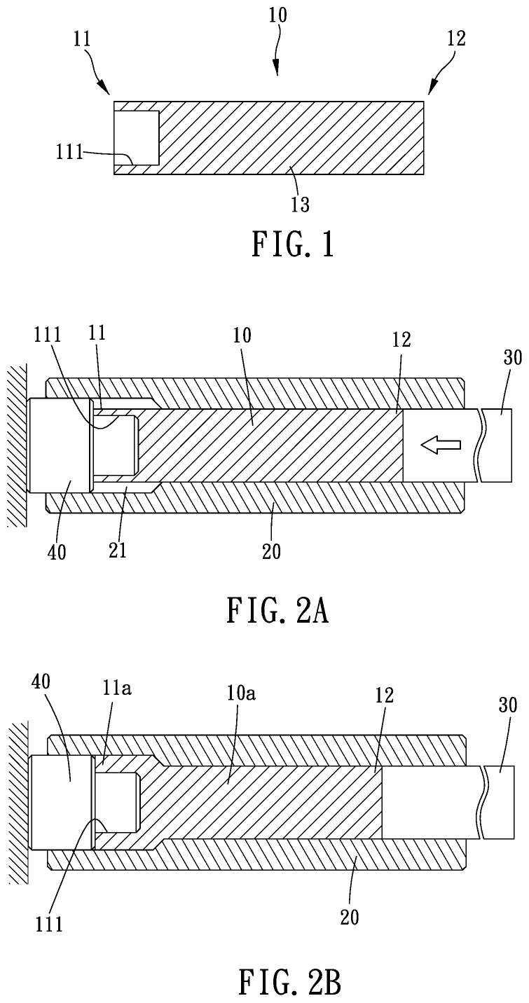

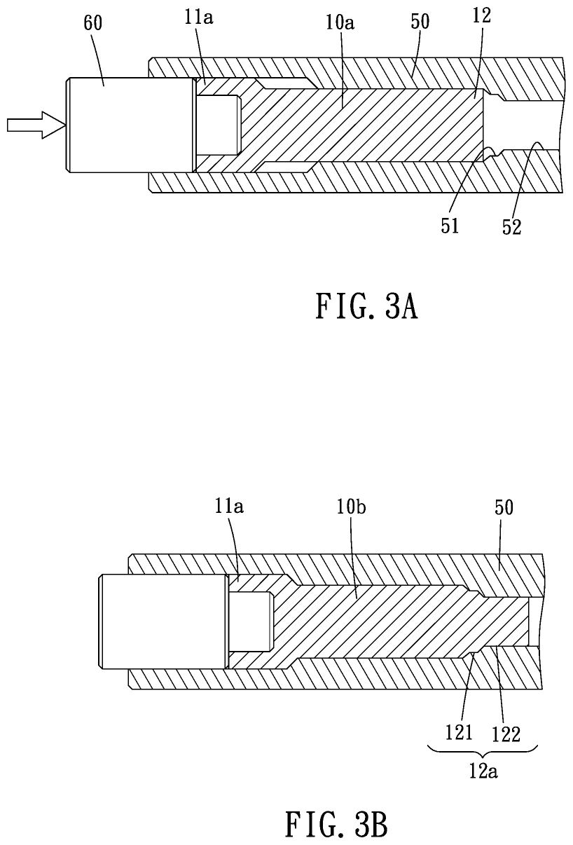

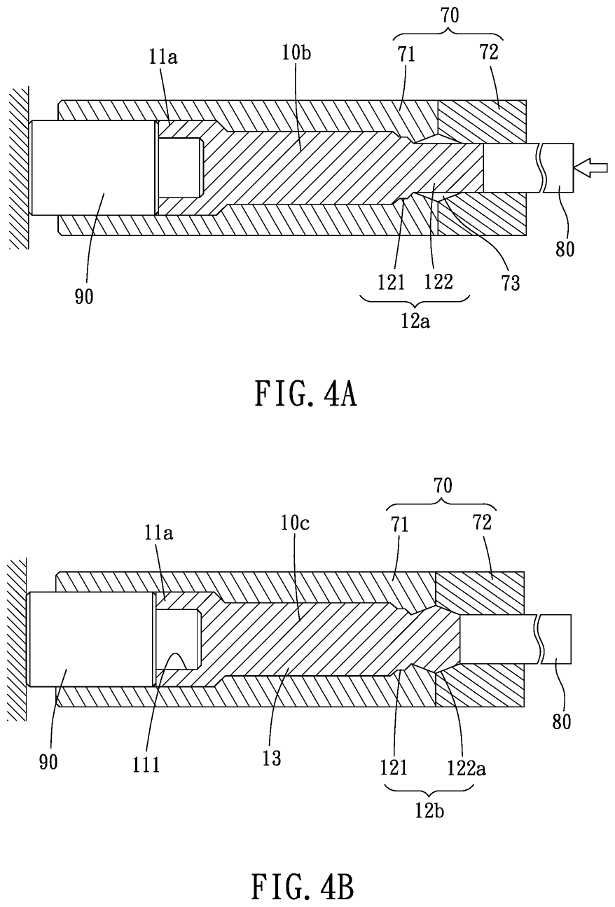

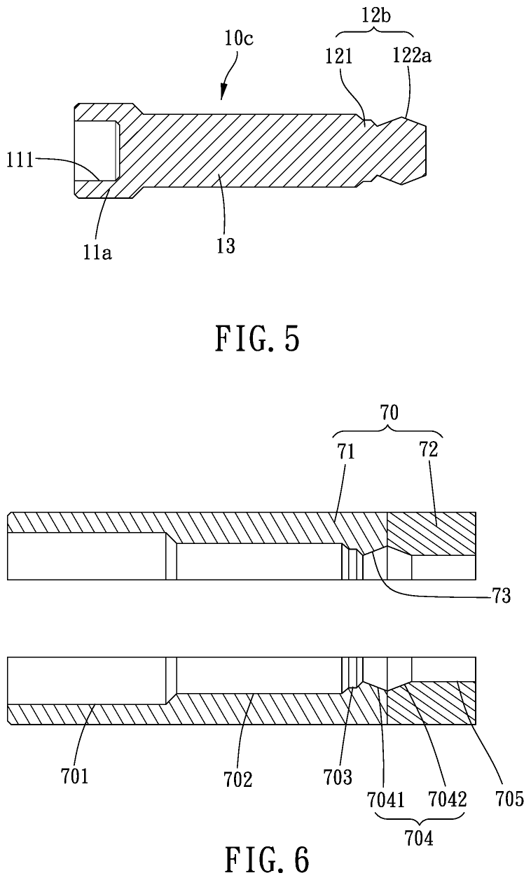

Please refer to FIG. 1 to FIG. 6, the method to manufacture connection rod using the mold mentioned above includes the following steps.

Prepare semi-product: Prepare a semi-product 10b from metal. The semi-product 10b is rod-shaped and has a first end 11a, a second end 12a, and an intermediate section 13 between the first end 11a and the second end 12a. The first end 11a has an outer diameter larger than or equal to an outer diameter of the intermediate section 13 and equal to the inner diameter of the first section 701 of the cavity. The intermediate section 13 has an outer diameter larger than the outer diameter of the second end 12a but equal to the inner diameter of the second section 702 of the cavity. The second end 12a includes a larger-diameter section 121 closer to the intermediate section 13 and a smaller-diameter section 122 remote from the intermediate section 13. The larger-diameter section 121 has an outer diameter than an outer diameter of the smaller-diameter section 122 but equal to the inner diameter of the third section 703 of the cavity. The outer diameter of the smaller-diameter section 122 is equal to the inner diameter of the fifth section 705 of the cavity.

Place into mold: Place the semi-product 10b into the cavity of the main body. The first end 11a of the semi-product 10b is located at the first section 701. The intermediate section 13 of the semi-product 10b is located at the second section 702. The larger-diameter section 121 of the semi-product 10b is located at the third section 703. The smaller-diameter section 122 of the semi-product 10b is located at the fourth section 704 and the fifth section 705. A shaping space 73 is formed between the fourth section 704 and the smaller-diameter section 122 of the semi-product 10b.

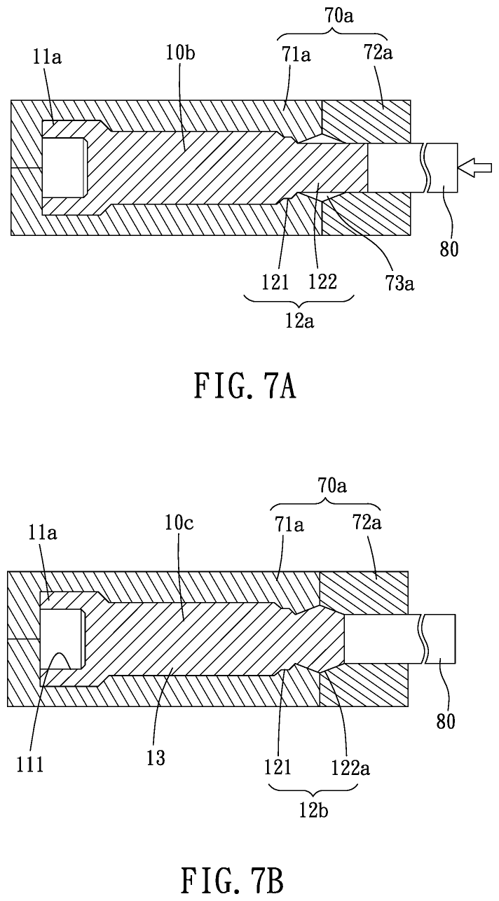

Cold forging: The semi-product 10b is prevented from moving toward the first end 11a by a positioning element 90 abutting against a free end of the first end 11a. A free end of the second end 12a is pushed and punched by a punching rod 80 toward the first end 11a so that a metal material of the second end 12a of the semi-product 10b is squeezed into the shaping space 73 to make the second end 12a radially expand to form a ball-joint 122a. In another embodiment of the present invention, as shown in FIG. 7A and FIG. 7B, the mold 70a is also composed of a first half-mold 71a and a second half-mold 72a and forms the shaping space 73a. However, an end of the first half-mold 71a near the first section is a closed end so that the first end 11a of the semi-product 10b abuts against the closed end. Thus, the positioning element is not necessary anymore.

About the semi-product, an intermediate product 10a is formed from a raw material 10 by a first shaping step, and the semi-product 10b is formed from the intermediate product 10a by a second shaping step. The raw material 10 has a first end 11, a second end 12, and an intermediate section 13 between the first end 11 and the second end 12. In the present embodiment, the first end 11 is axially formed with a hole 111. The intermediate product 10a also has a first end 11a, a second end 12, and an intermediate section 13 between the first end 11a and the second end 12. The first end 11, the second end 12, and the intermediate section 13 of the raw material 10 have a same outer diameter. The first end 11 of the raw material 10 is radially expanded to form the first end 11a of the semi-product 10b in the first shaping step. The second end 12 of the intermediate product 10a is radially reduced to form the second end 12a of the semi-product 10b in the second shaping step.

Specifically, in the first shaping step, the raw material 10 is placed into a first mold 20 having an expanded portion 21. The first end 11 of the raw material 10 is located at the expanded portion 21. A free end of the first end 11 of the raw material 10 is blocked, and a first punching rod 30 abuts against a free end of the second end 12 of the raw material 10 to push and punch the raw material 10 so that a metal material of the first end 11 of the raw material 10 is squeezed into the expanded portion 21 to make the first end 11 of the raw material 10 radially expand to form the intermediate product 10a. In the second shaping step, the intermediate product 10a is placed into a second mold 50 having a first reduced portion 51 and a second reduced portion 52. The second reduced portion 52 has a smaller inner diameter than that of the first reduced portion 51. The second end 12 of the intermediate product 10a has a larger outer diameter than the inner diameter of the first reduced portion 51. The second end 12 of the intermediate product 10a abuts against an end of the first reduced portion 51 remote from the second reduced portion 52. A second punching rod 60 abuts against a free end of the first end 11a of the intermediate product 10a to push and punch the intermediate product 10a so that a metal material of the second end 12 of the intermediate product 10a is squeezed into the first reduced portion 51 and the second reduced portion 52 to form the larger-diameter portion 121 and the smaller-diameter portion 122 of the semi-product 10b. It is noted that the first shaping step and the second shaping step can be exchanged.

Thereby, the connection rod 10c manufactured by the method mentioned above has a larger first end 11a with the hole 111, and the second end 12b has a ball-joint 122a. In addition, a recessed portion is formed between the rod body and the ball-joint to have a precise size and appearance. Besides, the process of cold forging is easy and simple so as to reduce cost and to increase the efficiency. In addition, no iron filings are generated so that the cost of processing the iron filings is saved, and that pollution is prevented.

What is claimed is:

1. A mold for manufacturing connection rod, including a main body, the main body being hollow to form a cavity and defining an axial direction, the cavity comprising a first section, a second section, a third section, a fourth section, and a fifth section along the axial direction, the first section having an inner diameter larger than or equal to an inner diameter of the second section, the inner diameter of the second section being larger than an inner diameter of the third section, the fifth section having an inner diameter smaller than or equal to the inner diameter of the third section, the fourth section having an inner diameter larger than the inner diameter of the third section and also larger than the inner diameter of the fifth section.

2. The mold for manufacturing connection rod of claim 1, wherein the fourth section includes a front section and a rear section along the axial direction, an inner diameter of the front section is expanded from an end thereof near the third section toward the rear section, an inner diameter of the rear section is tapered from an end thereof near the front section toward the fifth section so that the fourth section has a maximum diameter at a junction between the front section and the rear section.

3. The mold for manufacturing connection rod of claim 2, wherein the main body comprises a first half-mold and a second half-mold, the first half-mold has a first cavity, the second half-mold has a second cavity, the first half-mold and the second half-mold are connected axially so that the first cavity and the second cavity form the cavity together.

4. The mold for manufacturing connection rod of claim 3, wherein the first section, the second section, the third section, and the front section are located at the first half-mold, the rear section and the fifth section are located at the second half-mold.

5. The mold for manufacturing connection rod of claim 1, wherein the first section and the second section are connected by an inclined face therebetween, the second section and the third section are connected by an inclined face therebetween, the third section and the fourth section are connected by an inclined face therebetween.

6. A method to manufacture connection rod using the mold for manufacturing connection rod of claim 1, includes steps of:
preparing semi-product: preparing a semi-product from metal, the semi-product being rod-shaped and having a first end, a second end, and an intermediate section between the first end and the second end, the first end having an outer diameter larger than or equal to an outer diameter of the intermediate section and equal to the inner diameter of the first section of the cavity, the intermediate section having an outer diameter larger than the outer diameter of the second end but equal to the inner diameter of the second section of the cavity, the second end including a larger-diameter section closer to the intermediate section and a smaller-diameter section remote from the intermediate section, the larger-diameter section having an outer diameter than an outer diameter of the smaller-diameter section but equal to the inner diameter of the third section of the cavity, the outer diameter of the smaller-diameter section is equal to the inner diameter of the fifth section of the cavity;
placing into mold: placing the semi-product into the cavity of the main body, the first end of the semi-product being located at the first section, the intermediate section of the semi-product being located at the second section, the larger-diameter section of the semi-product being located at the third section, the smaller-diameter section of the semi-product being located at the fourth section and the fifth section, a shaping space being formed between the fourth section and the smaller-diameter section of the semi-product;
cold forging: the semi-product being prevented from moving toward the first end by a positioning element abutting against a free end of the first end, a free end of the second end being pushed and punched by a punching rod toward the first end so that a metal material of the second end of the semi-product is squeezed into the shaping space to make the second end radially expand to form a ball-joint.

7. The method to manufacture connection rod of claim 6, wherein an intermediate product is formed from a raw material by a first shaping step, the semi-product is formed from the intermediate product by a second shaping step, the raw material has a first end, a second end, and an intermediate section between the first end and the second end, the intermediate product also has a first end, a second end, and an intermediate section between the first end and the second end, the first end, the second end, and the intermediate section of the raw material have a same outer diameter, the first end of the raw material is radially expanded to form the first end of the semi-product in the first shaping step, the second end of the intermediate product is radially reduced to form the second end of the semi-product in the second shaping step.

8. The method to manufacture connection rod of claim 7, wherein in the first shaping step, the raw material is placed into a first mold having an expanded portion, the first end of the raw material is located at the expanded portion, a free end of the first end of the raw material is blocked, a first punching rod abuts against a free end of the second end of the raw material to push and punch the raw material so that a metal material of the first end of the raw material is squeezed into the expanded portion to make the first end of the raw material radially expand to form the intermediate product.

9. The method to manufacture connection rod of claim 7, wherein in the second shaping step, the intermediate product is placed into a second mold having a first reduced portion and a second reduced portion, the second reduced portion has a smaller inner diameter than that of the first reduced portion, the second end of the intermediate product has a larger outer diameter than the inner diameter of the first reduced portion, the second end of the intermediate product abuts against an end of the first reduced portion remote from the second reduced portion, a second punching rod abuts against a free end of the first end of the intermediate product to push and punch the intermediate product so that a metal material of the second end of the intermediate product is squeezed into the first reduced portion and the second reduced portion to form the larger-diameter portion and the smaller-diameter portion of the semi-product.
